(19) United States
(12) Patent Application Publication
(10) Pub. No.: US 2005/0116427 A1
(43) Pub. Date: Jun. 2, 2005

(54) Corrugated gasket core with profiled surface

(76) Inventors: Francis Seidel, Houston, TX (US); Richard Davis, Montgomery, TX (US); Dan Reid, Kingwood, TX (US)

Correspondence Address: John M. Harrington;Kilpatrick Stockton LLP, 1001 West Fourth Street, Winston-Salem, NC, 27101, US

(21) Appl. No.: 10/996,842

(22) Filed: Nov. 24, 2004

Related U.S. Application Data
(60) Provisional application No. 60/524,748, filed on Nov. 25, 2003.

(51) Int. Cl. F16L 17/06

(52) U.S. Cl. 277/610

(57) ABSTRACT

A gasket is provided comprising a gasket core having an outer portion and an inner portion defining an aperture, and opposing first and second faces, wherein at least a portion of the core is corrugated through its thickness and at least one face is at least partially profiled, and a gasketing material disposed upon said at least one partially profiled face. The profiling comprises a series of concentric grooves formed into the core material and the corrugation preferably comprises a sinusoidal-shaped wave comprising concentric rings of peaks and valleys.

### CROSS REFERENCE TO RELATED APPLICATIONS

The present application claims priority under 35 U.S.C. § 119(e) from U.S. Provisional Patent Application Ser. No. 60/524,748 filed Nov. 25, 2003, entitled “Gasket With Serrated Surface and Corrugated Core”, the disclosure of which is incorporated herein by reference.

### FIELD OF THE INVENTION

The present invention relates to gaskets for sealing the juncture between opposing flanges. More particularly, the present invention relates to gaskets having a semi-rigid substrate comprising opposing faces that are both profiled and corrugated.

### BACKGROUND OF THE INVENTION

Corrugated metal gaskets are comprised of a thin gauge metal substrate that is corrugated, then covered with a soft gasket material. Examples of these gaskets are illustrated in U.S. Pat. Nos. 5,421,594; 5,785,322; and 6,092,811 all of which are hereby incorporated by reference. The corrugated metal design provides greater resiliency than the flat homogeneous gasket material alone. The resiliency of the substrate results in a gasket that continues to provide compressive forces on the soft gasket material against the mating flanges. This compressive force maintains sealing forces against the flanges even as the soft gasket material creeps or takes compression set. The use of these corrugated metal core gaskets is common in pressure vessels and piping systems.

One substantial limitation of this design is the inability of the gasket to withstand high internal pressures. These gaskets have been shown to fail at internal pressures of approximately 2,000 psi. This failure occurs in part because the gasket material does not sufficiently mechanically bond to the metal substrate, and therefore has a limited amount of shear resistance to overcome high internal system pressures.

One attempt to solve this problem is the Kammprofile gasket. The Kammprofile gasket comprises a metal substrate with profiled faces to which sealing elements are attached. This design overcomes the high-pressure limitation of the prior art through the use of a serrated surface that is formed into the metal substrate. The metal core is of a thicker gauge than the corrugated gaskets, and the forming process results in a more pronounced surface texture. The serrated surface provides significant mechanical resistance to the shearing of the soft gasket material as it is deformed into the serrations by the compressive force applied by the flanges. As a result, this design has been shown to withstand much higher pressures (over 5,000 psi.) as compared to that of the corrugated metal design. However, a drawback to the profiled design is the lack of resiliency seen in the corrugated metal gaskets. Because of this lack of resiliency, the sealing forces in the flanges connection will degrade over time due to the tendency of the soft gasket material to creep or take compression set.

It would, therefore, be desirable to provide a gasket with the resiliency of a corrugated metal gasket and the high-pressure performance characteristics of the Kammprofile family of gaskets.

### SUMMARY OF THE INVENTION

In a first aspect of the present invention a gasket is provided comprising a gasket core having an outer portion and an inner portion defining an aperture, and opposing first and second faces, wherein at least a portion of the core is corrugated through its thickness and at least one face is at least partially profiled, and a gasketing material disposed upon said at least one partially profiled face.

In a preferred embodiment of the present invention, both opposing faces are profiled and the profiling comprises a series of concentric grooves formed into the core material. The corrugation preferably comprises a sinusoidal-shaped wave comprising concentric rings of peaks and valleys.

The gasketing material may comprise expanded graphite, fluorocarbon polymer, or a fluorocarbon polymer with a graphite filler. The gasketing material is preferably adhered to the gasket face with an adhesive, such as a pressure sensitive adhesive or spray adhesive.

As will be realized by those of skill in the art, many different embodiments of a gasket according to the present invention are possible. Additional uses, objects, advantages, and novel features of the invention are set forth in the detailed description that follows and will become more apparent to those skilled in the art upon examination of the following or by practice of the invention.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

So that the manner in which the above-recited features, advantages and objects of the invention, as well as others which will become more apparent, are obtained and can be understood in detail, a more particular description of the invention briefly summarized above may be had by reference to the embodiment thereof which is illustrated in the appended drawings, which drawings form a part of the specification and wherein like characters of reference designate like parts throughout the several views. It is to be noted, however, that the appended drawings illustrate only preferred and alternative embodiments of the invention and are, therefore, not to be considered limiting of its scope, as the invention may admit to additional equally effective embodiments.

### BRIEF DESCRIPTION OF THE DRAWINGS

FIG. 1 is a side view of a gasket in an embodiment of the present invention.

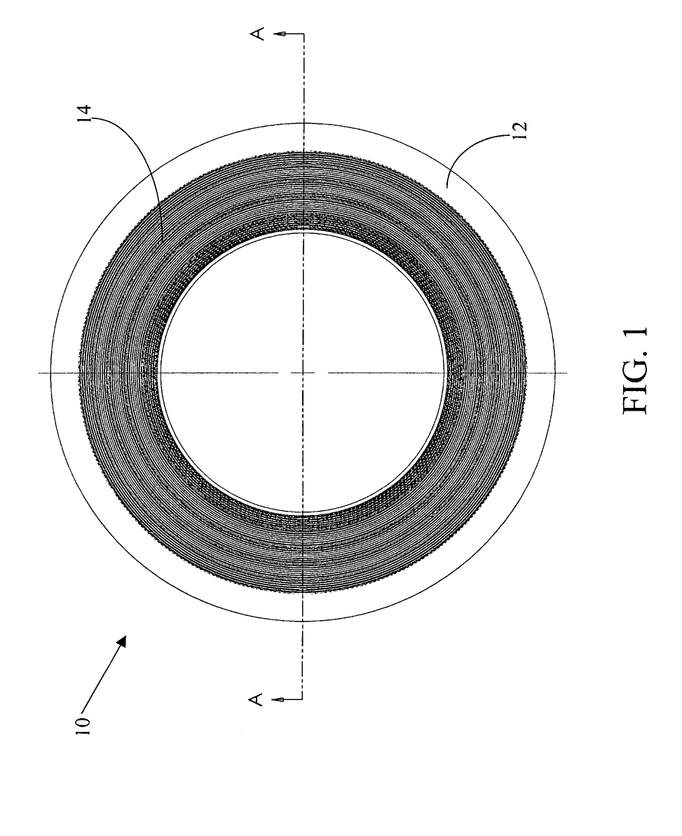

FIG. 2 is a section view of the gasket core of FIG. 1 taken along line A-A in an embodiment of the present invention.

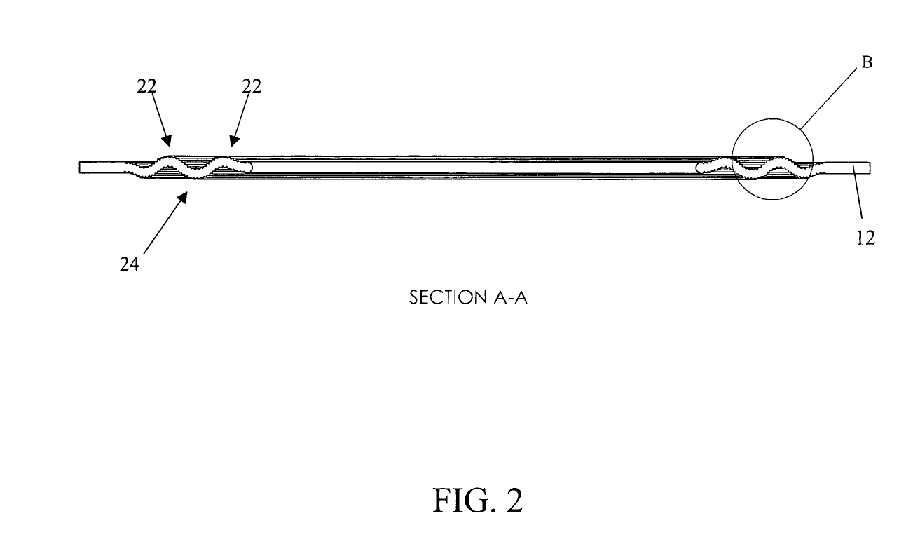

FIG. 3 is a detail view of the area designated “B” in FIG. 2 in an embodiment of the present invention.

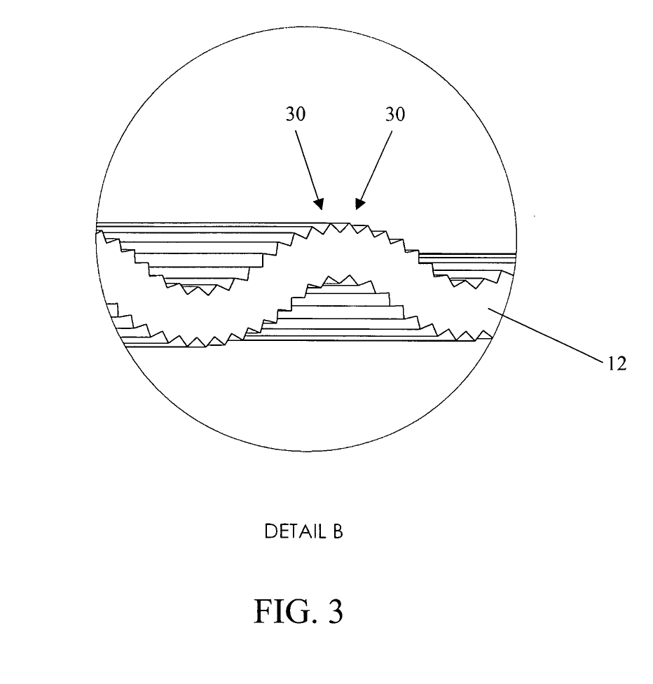

FIG. 4 is an isometric view of a gasket in an embodiment of the present invention.

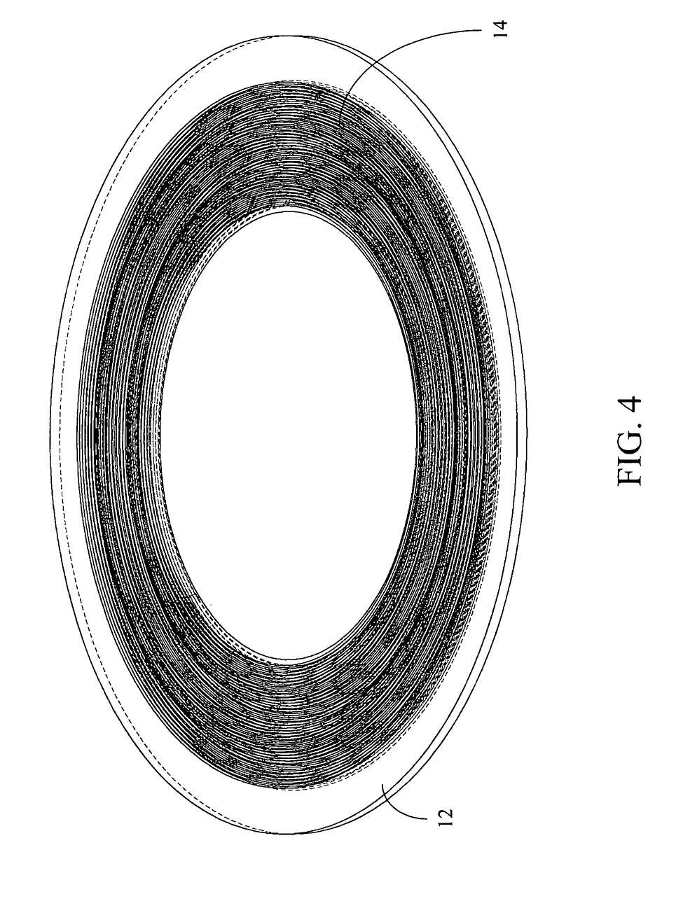

### DETAILED DESCRIPTION

In a first aspect of the present invention, a gasket is provided comprising a rigid core having corrugations formed therein and two profiled faces, the core being encapsulated by a gasketing material. In a preferred embodiment of the present invention, the profiled faces comprise a series of concentric peaks and grooves formed in the gasket surface to a predetermined depth. In a further preferred embodiment of the present invention, the corrugations comprise a sinusoidal pattern of concentric peaks and valleys formed through the entire thickness of the core material such that the second face of the gasket has the opposing corrugation pattern (peaks and valleys) of the first.

Referring to the figures, a gasket 10 according to an embodiment of the present invention is shown comprising a core material 12 which is at least partially encapsulated with a gasketing material 14. The core material 12 is corrugated from the inner diameter through a portion of the material. The corrugations form peaks 22 and valleys 24 in each face, with the first face having the opposite pattern from the second, i.e. the corrugations extend through the thickness of the material. The top and bottom faces of the gasket are profiled 30 with small grooves formed into the surface of the core material 12. In a preferred embodiment of the present invention, the grooves are generally coexistent with the corrugations, both beginning at the inner diameter of the gasket and extending to a point less than the outer diameter of the gasket.

The core is typically constructed of a metallic material. In a preferred embodiment of the present invention, the core is constructed of stainless steel, such as 304, 309, 310, 316, 321, 347, 410, 430, and 501 stainless steel. The selection of the metal depends upon the metallurgy of the flanges (or other surfaces) to be sealed, and the degree of chemical resistance desired from the metal gasket core. For example, metal gasket cores can be formed from Alloy 20, aluminum, brass, copper, Hastelloy® B and C, Inconel® 600, Incolloy® 825, Monel®, nickel, phosphor bronze, tantalum, and titanium.

The geometry of the profiled faces may come in many forms. In a preferred embodiment of the present invention, the profiled faces comprise a multitude of “serrations”, grooves, or alternating peaks and valleys cut into the surface of the core material. The peaks and grooves form a “V inverted-V” pattern with sharp peaks and likewise sharp grooves. However, in an alternate embodiment of the present invention, the profile may also be a plurality of “U-inverted U” shapes, or other similar shapes or combinations thereof.

The geometry of the corrugations may come in many forms. In a preferred embodiment of the present invention, the corrugations comprise gentle curves forming a sine wave like cross section. However, in other embodiments of the present invention, the corrugations may also be a plurality of “V-inverted V” shapes, “U-inverted U” shapes, or other similar shapes or combinations thereof.

The profiled, corrugated core is surrounded by a gasketing material. In a preferred embodiment of the present invention, the gasketing material comprises expanded graphite. The graphite material is typically an expanded graphite, preferably a nuclear grade, at least about 95% pure graphite (carbon), having no binders or resins, and having less than 50 parts per million leachable chloride and/or fluoride content.

In one embodiment of the present invention, the graphite material is a flexible expanded graphite material, sold under the names Grafoil®, Sigraflex®, Flexicarb® or Calgraph®. It is preferred to employ a nuclear grade, at least about 95% pure graphite (carbon), having no binders or resins, and having less than 50 parts per million leachable chloride and/or fluoride content. In a preferred embodiment of the present invention, the graphite is adhered to the gasket core with a spray adhesive, such as the spray adhesive Super 77™ sold by the 3M Corporation. In another embodiment of the present invention, the graphite is adhesively affixed to a Mylar material having a double-sided coating of a pressure sensitive adhesive material. The graphite/Mylar laminate is affixed to the exterior of the corrugated gasket core. The graphite material preferably conforms to, and maintains the corrugation contour, and extends beyond the outside edges of the core ring gasket to partially encapsulate the core gasket in the graphite material.

In another embodiment of the present invention, the gasketing material may be a chemically resistant polymer material such as a fluorocarbon polymer, preferably polytetrafluoroethylene (PTFE). The graphite and/or chemically resistant materials are typically applied as a sheath having a thickness sufficient to coat the corrugations of the core, while maintaining the gasket's corrugated contour.

In a still further embodiment of the present invention, other gasketing materials may be employed. The selection of the gasketing material may depend upon the chemical composition of fluids (i.e., liquids and/or gases, with or without solids) which may contact the gasket, and the temperature, pressure, or other operating conditions to which the gasket may be exposed. However, materials which are both resilient and chemically resistant are preferred. In one embodiment of the present invention, the gasketing material is a fluorocarbon polymer which is adhesively affixed to a Mylar material having a double-sided coating of pressure sensitive adhesive material. Fluorocarbon polymers are characterized by their thermoplastic properties, resistance to chemicals, moisture, solvents, and oxidation, non-combustibility, and broad useful temperature range (i.e., up to 316° C.). The structure of fluorocarbon polymers comprises a straight back-bone of carbon atoms symmetrically surrounded by fluorine atoms.

Expanded fluorocarbon polymers such as polytetrafluoroethylene (PTFE), polyvinylidene fluoride, hexafluoropropylene, fluorinated ethylene-propylene polymers, and chlorotrifluoroethylene polymers are preferred because of their resilience, chemical resistance, low torque sealing, and limited cold flow or creep. These expanded fluorocarbon polymers may be sold under the names Teflon®, Halon®, Viton®, Gylon®, Intertex®, and Gore-Tex®. The characteristic of limited cold flow is particularly desirable in a gasket used in conditions where the seating stress of a flange may diminish over time.

In one embodiment of the present invention, the gasket is employed to seal a pair of parallel flanges at the juncture of two pipes. The flanges typically are secured together with threaded shafts or bolts and nuts to create a fail-safe, multi-sealed connection in a pipeline used in, for example, the petrochemical industry. In a preferred embodiment of the present invention, the bolts extend through the retainer ring of the gasket thereby ensuring proper positioning and alignment of the gasket within the flange assembly.

In one embodiment of the present invention, the gasket with profiled surface and corrugated core was manufactured in accordance with the following method.

(1) A 1/16-inch thick (uncorrugated) 304 stainless steel was cut to a square size having a sides at least equal to the desired gasket O.D.; thus, the diagonal length was at least 4⅛ inches.

(2) The square of 1/16-inch steel was then center punched.

(3) The square was then circle-sheared to cut out a circle having a diameter equal to the desired gasket O.D.; thus, the diameter of this circle was 4⅛ inches.

(4) The 1/16-inch thick, 4⅛ inch diameter circle was then profiled, to cut 10/1000-inch deep grooves in both surfaces of the circle having a peak to peak width of 20/1000 inches resulting in approximately 50 grooves/inch across the surface. The grooves are preferably designed to form a plurality of concentric, circular, parallel rings defined by the ridges, peaks, or apexes and the hollows, troughs, or valleys, which, in the case of a pipeline flange gasket, are concentric with the circumferential inner border and outer border of the gasket core.

(5) The 1/16-inch thick, 4⅛ inch diameter circle of profiled steel was then corrugated, using a spinning roller system having male and female dies of the undulating arch pattern to create the sinusoidal shaped corrugations having a peak to peak corrugation width of ¼ inch. In this embodiment, the corrugations are designed to form a plurality of concentric, circular, parallel rings defined by the ridges, peaks, or apexes and the hollows, troughs, or valleys, which, in the case of a pipeline flange gasket, are concentric with the circumferential inner border and outer border of the gasket core.

(6) The profiled, corrugated, 4⅛ inch diameter circle was again circle-sheared to cut out an inner circle, thereby leaving a ring having an outer diameter of 4⅛ inches, and an inner diameter of 2¾ inches in diameter.

(7) Expanded graphite sheet material (e.g., the 0.020 inch thick Calgraph® or Flexicarb® expanded graphite sheet) was obtained, and a pressure sensitive double-sided adhesive (having Mylar backing, 0.002 inch thick) was applied to the expanded graphite material. The double-sided adhesive typically is available in sheets containing quick-release, peel-off layers on both sides to protect the adhesive until use.

(8) The expanded graphite/adhesive composite was then die stamp cut with a Rule Steel die having the desired dimensions (here, 4⅛ inches O.D.×2¾ inches I.D.) to create two matching ring-shaped graphite/adhesive laminates.

(9) The corrugated metal core was then encapsulated from the outer border to the inner most trough with the expanded graphite by laminating and molding both sides of the core material with the laminate layers of 0.022-inch thick adhesive-backed expanded graphite. A first ring-shaped laminate layer was symmetrically and proportionally aligned with the metal core. Sufficient pressure was applied to the first laminate layer to adhere it to the core and to maintain such alignment with the core until the second laminate layer was applied. The second laminate layer was applied in similar fashion to the opposite face of the metal core.

(10) The laminated gasket was then placed between two foam/cloth padded rollers. Compression was applied to the rollers, and the gasket was rotated around the rollers in circular fashion to mold and compress the adhesive-backed graphite laminates into the individual corrugations (i.e., the area defined by the ridges, peaks, or apexes and the hollows, troughs, or valleys), such that the graphite layers adhere to the core and maintain the contour of the corrugation.

(11) As an additional step to the above-described method, it may be desirable to apply heat to the gasket surface sufficient to carbonize the Mylar or other suitable backing of the expanded graphite layers.

It will be apparent to those skilled in the art that other suitable mechanical means may be employed for creating the profiled faces and corrugations in the gasket core. For example, in addition to the spinning roller method described, milling, molding, stamping, and other techniques may be employed to create the desired geometry. It will likewise be apparent to those skilled in the art that other suitable shapes for the profile grooves and corrugations may be employed for creating the corrugation on the gaskets.

In addition, the circumferential shape of the gasket and the shape of the gasket aperture of this invention are not limited to circles. For example, gaskets having an outline and/or aperture defining any shape, for example, oval, square, rectangular, triangular, elliptical, oblong, epicycloid, and/or any combination thereof, may be used. While a circular ring shape is the desired gasket shape for use on a pipe flange, other gasket shapes can be manufactured depending on the shape of the surfaces to be sealed. Furthermore, although the discussion of the various embodiments of a gasket according to the present invention suggest use in a raised flange pipeline connection, other variations of this gasket are possible to accommodate differing flange connection scenarios. For example, a pipeline flange gasket of the invention can be employed where the flange connection requires the gasket to extend diametrically beyond the flange bolt holes.

Other graphite products may also be employed, such as the 0.020-inch thick Grafoil® product which is available with a 0.002-inch Mylar adhesive layer on one side. Other means are available for adhering the graphite and/or fluorocarbon polymer to the corrugated core, such as by compression molding techniques, or other adhesive techniques. Although a Mylar material with pressure sensitive adhesive on both sides is useful for its temperature stability and carbonization characteristics, other suitable adhesives could be employed.

As described above, the uncorrugated core metal thickness may be 1/16 inches, the corrugation peak width may be ¼-inches, and the groove angle may be 90°. However, a wide variety of combined core material thickness, corrugation peak widths, and gasketing material thickness are within the scope and spirit of this invention. For example, gaskets may include a core material thickness of 1/100-1/10 inches; corrugation peak widths of 1/16-½ inches; gasketing material layer thickness of 0.01-0.075-inch (with an additional 0.002-inch adhesive). For example, in pipe flange connections having ¼ inch to ½ inch flange face widths or ½ inch to 3½ inch flange I.D., it is preferred that the corrugation width be 3/32 inches. For pipe flange connections having 9/16 inch or greater flange face widths or 4 inch or greater flange I.D., the preferred corrugation width is 5/32 inches. Moreover, the absolute and relative widths of the gasketing material layers may be varied depending upon the expected operational conditions and the particular material used.

The beneficial multi-sealing characteristics of the profiled, corrugated, graphite and/or fluorocarbon polymer encapsulated gasket of this invention also have application in irregularly-shaped configurations, such as those required for heat exchanger gaskets, or other shape requirements, such as oval, square, rectangular, triangular, elliptical, oblong, and/or epicycloid shaped gaskets, and/or any combination thereof. For example, heat exchanger gaskets typically have a circular outer diameter and inner diameter, similar to a pipe flange gasket, but additionally contain partitioned chambers within the confines of the inner diameter area of the gasket.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

1. A gasket, comprising:
a gasket core having an outer portion and an inner portion defining an aperture, and opposing first and second faces, wherein at least a portion of the core is corrugated through its thickness and at least one face is at least partially profiled; and
a gasketing material disposed upon said at least one partially profiled face.

2. The gasket of claim 1, wherein both opposing faces are profiled.

3. The gasket of claim 1, wherein said profiling comprises a series of concentric grooves formed into the core material.

4. The gasket of claim 1, wherein said corrugation comprises a sinusoidal-shaped wave comprising concentric rings of peaks and valleys.

5. The gasket of claim 1, wherein said gasketing material comprises expanded graphite.

6. The gasket of claim 1, wherein said gasketing material comprises a fluorocarbon polymer.

8. The gasket of claim 1, wherein said gasketing material comprises a fluorocarbon polymer with a graphite filler.

9. The gasket of claim 1, wherein said gasketing material is adhered to the gasket face with an adhesive.

10. The gasket of claim 9, wherein said adhesive comprises a pressure sensitive adhesive.

11. The gasket of claim 9, wherein said adhesive comprises a spray adhesive.
